(19) United States
(12) Patent Application Publication
(10) Pub. No.: US 2003/0073227 A1
(43) Pub. Date: Apr. 17, 2003

(54) Simple, fully transportable device for maintaining an excised heart in optimum condition for transplantation

(76) Inventors: Harry F. Hull, Vinhedo (BR); Edward F. Good, Houston, TX (US)

Correspondence Address: CALFEE HALTER & GRISWOLD, LLP, 800 SUPERIOR AVENUE, SUITE 1400, CLEVELAND, OH, 44114, US

(21) Appl. No.: 10/259,021

(22) Filed: Sep. 27, 2002

Related U.S. Application Data
(60) Provisional application No. 60/325,594, filed on Sep. 28, 2001.

(51) Int. Cl. A01N 1/02

(52) U.S. Cl. 435/284.1

(57) ABSTRACT

An apparatus for transporting and maintaining an excised heart in condition for transplantation includes a container defining a chamber for receiving the heart, and a body of physiologic fluid disposed in the chamber. A pump is provided for pumping the fluid into the heart, and a source of oxygen under pressure. Oxygen flow structure continuously directs flow of pressurized oxygen into the fluid thereby to oxygenate the fluid and to maintain the pressure in the chamber at a pressure above atmospheric pressure. An aorta supply line directs fluid from the pump to the aorta and thence into the coronary arteries to force perfusion of the vascular bed of the heart.

### BACKGROUND OF THE INVENTION

1. Technical Field

This invention relates to a device for maintaining an organ such as a human heart, which has been excised from the donor, in optimum conditions for transplant to the recipient. This device has the added benefit of extending the time that the heart is viable when compared to present practices for heart preservation during transplant.

The invention contemplates the use of hyperbaric oxygen pressures in conjunction with a perfusion system for circulating oxygenated fluid through the coronary arteries, all in a compact and fully transportable package.

Another objective of the invention is to permit the transport of a donor heart over long flight times at relatively high cabin altitudes as are encountered in modern jet airplanes, thereby improving the chances of a donor—recipient match.

2. Discussion

Human heart transplant is a recognized medical procedure. It involves maintaining the heart functioning in the donor until and after certified brain death until the organ can be excised. After certified brain death, when the heart is to be excised, the circulatory system is injected with an anticoagulant such as heparin to prevent blood clotting within the heart. The heart is then stopped, excised and immersed in cold physiological solution at around 4° C. The cold solution prevents the heart from beating, and at the same time reduces cell metabolism.

While cell metabolism is reduced, it does not stop completely. Because the cells are deprived of substrate, i.e., oxygen and glucose, there begins an inexorable process of degradation of the metabolic process that eventually leads to cell death. As a result of metabolism, carbon dioxide is produced as well as toxic by-products such as oxygen free radicals and hydroxyl radicals that can attack healthy tissue. If not removed or neutralized, they will increase in concentration to dangerous levels.

The final result of the above is that a heart excised from the donor has a finite time during which it is viable for transplant. Under current practice, the deterioration process begins immediately upon cessation of heart muscle oxygenation (cessation of beating) and continues until circulation and oxygenation begins again with the transplanted heart functioning in the recipient. This means that the heart will always be in less than ideal condition when transplanted, depending on the amount of time it remains stopped. Ideally, the heart will be transplanted within approximately four hours of harvesting. After this period of time, the degradation may have progressed to the point that the heart is no longer viable, thereby reducing the chances for a successful transplant. Such a short time frame means that the geographic radius from which a heart may be retrieved is quite short. Anything that interferes with the transportation process (bad weather, an accident, etc.) may mean that the heart is lost. Also, during the transportation process, the recipient must be in the hospital operating room prepared to receive the heart in the shortest period of time after its arrival in the hospital.

Hyperbaric oxygen therapy (HBOT) contemplates the use of a hyperbaric chamber (pressurized vessel) where pressures above one atmosphere absolute (ATA) can be applied to the patient. The patient breathes 100% oxygen during the period of treatment. Since normal air is approximately 21% oxygen, during HBOT the lungs are receiving nearly 5 times the oxygen they would receive during normal respiration. With increased oxygen availability and increased pressure, the amount of oxygen dissolved in the blood plasma is increased. This increased availability of oxygen has therapeutic value in treating a wide variety of health disorders including infection, gangrene, conditions caused by reduced circulation, burns, and other conditions.

It is common knowledge among those who study and work with HBOT that under hyperbaric pressures (>1 ATA), solubility of oxygen in blood plasma (or any liquid) increases as the partial pressure of oxygen increases. At hyperbaric pressures of around 2.5 ATA, oxygen partial pressures can exceed the partial pressure of oxygen attached to hemoglobin, thereby permitting cells to absorb oxygen directly from the fluid. In other words, it is not necessary to have blood (hemoglobin) circulation in order to have cell oxygenation and metabolism.

Ischemia is described as “a lack of blood supply in an organ or tissue”. Ischemia results in a deficiency of oxygen in the organ or tissue. In transplant, as in other procedures and diseases, reperfusion of an ischemic organ or tissue may result in “reperfusion injury”. Those skilled in the art know of the devastating effects of reperfusion injury and the wide range of chemical reactions that occur. HBOT may reduce reperfusion injury by reducing ischemia.

Research has been conducted showing that hyperbaric pressure may increase the time that an organ remains viable for transplant.

Under normal heart function, the left ventricle contracts, ejecting oxygenated blood through the aortic valve and the aorta for distribution to the rest of the body. This contraction causes increased pressure within the arterial circulatory system, that causes the elastic arteries to expand. The peak pressure is called the systolic blood pressure (around 120 mm Hg.). As the ventricle relaxes and is again filled with blood from the left atrium, the elastic arteries recoil, thereby maintaining a pressure within the arterial system. The pressure, however, continues to reduce, as blood flows throughout the body, to its lowest pressure called the diastolic pressure (around 70 mm Hg.). After systolic pressure is passed and the arteries are recoiling, backpressure of the blood (greater pressure in the aorta than in the ventricle) causes the aortic valve to close, preventing the flow of blood back into the ventricle. This backpressure also causes blood to flow through the coronary arteries into the vascular bed of the heart, thereby oxygenating the heart muscle and flushing out CO₂ and toxic by-products of metabolism.

Transportation of a heart over a significant distance is almost always accomplished by using a private jet aircraft or a jet airliner. These airplanes are pressurized to reduce the cabin altitude to a level that is comfortable for the passengers and crew without breathing supplemental oxygen. In a modern pressurized aircraft, flying at an altitude of 11,500 meters, the cabin altitude may be 2,200 meters or more, as the pressurization system is not capable of maintaining a cabin altitude near sea level. In a modern turbocharged unpressurized aircraft the cabin altitude may be as high as 6,700 meters, or higher. In such cases, the use of a hyperbaric chamber isolates the heart from the surrounding atmosphere, maintains it under constant pressure for maximum oxygenation, and avoids low-pressure conditions which are prejudicial to cell oxygenation.

### PRIOR ART

Swenson and Koski, U.S. Pat. No. 3,406,531 describes an “Apparatus for Maintaining Organs in a Completely Viable State”. The use of a hyperbaric chamber pressurized with oxygen is described, whereby the organ is suspended in a physiologic solution, at hypothermic temperatures, and hyperbaric pressures. The system, however, fails to consider transportability, as it is apparently quite heavy due to the weight of the refrigeration system, and also requires an electric energy source to drive the motorcompressor. Finally, the system fails to consider perfusion of the organ, or initial or continuous oxygenation of the preservation solution.

De Roissart, U.S. Pat. No. 3,772,153 employs many of the principles of the above patent, however employing organ perfusion. Again, the system is not transportable, and must be maintained in a level position in order to function. Transportabilility is essential in a successful transplant program in order to match donors and recipients that are normally located at some distance one from the other. The necessity of employing both an arterial connection and a venal connection complicates the system.

Time is of the essence when removing and treating a donor heart. Those skilled in the art know that at normothermic temperatures (37° C.), a heart remains viable for a maximum of around 15 minutes from the time circulation is stopped until some form of protection or oxygenation of the heart muscle is initiated. U.S. Pat. No. 5,807,737 contemplates using the heart, lungs, and trachea of the donor to maintain the heart in a viable state. The heart is maintained in a beating mode, while blood (preferably autologous) is circulated through the lungs where it is oxygenated as in normal function. A mechanical device provides respiration. The device is not fully transportable as it requires electric energy to operate, and there is no provision for a transportable supply of electricity. In addition, the device is immensely complex, having a plurality of connections to make, probes to insert and monitor, and human blood to circulate; and all this must be accomplished within the above time limit. These factors limit the practicality of this device.

Gardetto, et al, U.S. Pat. No. 5,965,433 covers a “Portable perfusion/oxygenation module having a mechanically linked dual pumps and mechanical actuated flow control for pulsatile cycling of oxygenated perfusate.” The patent states, “Hence, satisfactory oxygen transport is achieved by exposing the perfusate to a gas phase under pressure, the pressure available being limited by the design of the oxygenating chamber and also by the limits of perfusion pressure that can be applied within the vessels of the perfused organ without causing damage.” As stated above, cabin altitudes in a modern jet airliner may reach 2200 meters or more. At 2200 meters of altitude, the atmospheric pressure is 0.743 ATA, or a reduction of 25.7%. This reduction of 25.7% has two effects, 1) the solubility of oxygen in the aqueous perfusate is reduced by approximately 25%, and 2) the perfusion pressure must be reduced by 25% in order that the differential pressure between the exterior of the organ and the perfused vessels of the organ not exceed the physical limits. These two factors, which have a cumulative effect on the oxygenation of the organ, may make the system inoperable, or at best, operable with considerably reduced efficiency.

Hassanein, U.S. Pat. Nos. 6,046,046 and 6,100,082, describes a perfusion apparatus to perfuse a heart or other organ at normothermic temperatures, maintaining the heart in a beating state, while circulating blood or blood/fluid mixtures. In this system, a supply of hemoglobin is essential to have enough oxygen available in the fluid media to maintain cell oxygenation. If the system depends on the solubility of oxygen in the fluid media to maintain adequate cell oxygenation, it may fail at high altitudes. Pressure measurements made in the system are differential pressure measurements made in relation to the ambient atmospheric pressure. At high altitudes, the ambient atmospheric pressure is reduced, and the flow of fluid media will be reduced to maintain the same differential pressure. If fluid media flow is maintained, the circulatory system of the organ may be compromised by overpressures. In addition, the device is not a simple device. In one embodiment of the patents, four connections must be made to the heart, one of which is an invasive connection through the left atrium in order to place a pressure probe in the left ventricle. Because the organ is maintained in a beating mode, it requires multiple nutrient replenishing solutions to be administered constantly during the preservation period.

### SUMMARY OF THE INVENTION

Unlike other vital organs that are transplanted, the heart is unique in that, very early in life, its cells lose the ability to proliferate, which means that it cannot regenerate. Thus, it must be treated under special conditions in order to be maintained in a viable condition. The present invention contemplates the use of hyperbaric pressures to provide oxygen in solution at partial oxygen pressures sufficient to allow transport to cells for use in metabolic processes. It also provides for circulation of oxygenated physiological solution containing nutrients to provide the substrate for cell metabolism. Additionally, the solution will flush out, dilute and neutralize toxic products and CO₂.

Some features of the system of the present invention are as follows:

1. Fully transportable.

2. Compensates for reductions in atmospheric pressure.

3. Provides controls for maintaining the hyperbaric chamber under pressure with a continuous flow of oxygen-containing gas.

4. Provides for continuous oxygenation of the physiological solution.

5. Provides for the continuous perfusion of the coronary arterial bed with oxygenated physiological solution.

6. Provides an insulated container for maintaining the hyperbaric chamber and contents' at low temperatures.

7. Allows for rapid connection of the heart to the system, utilizing only one cannular connection to the aorta.

8. Maintains the organ and perfusate under sterile conditions.

9. Can be operated by minimally trained personnel.

While the invention herein described refers to the preservation of a human heart, one skilled in the art will readily see that the system might be beneficial for the preservation of other organs to be transplanted.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic of the hyperbaric chamber and the gas and pressurization components;

FIG. 2 is a schematic of the front panel of the electrical box showing the lights and meters that monitor the electrical system;

FIG. 3 is a schematic of the components located inside the electrical box and the battery and external connections of the circuit;

FIG. 4 is an elevational view of an aortic cannula that forms part of the system of the present invention;

FIG. 4A is an elevational view similar to FIG. 4 of an aortic cannula having a different aortic insertion dimension;

FIG. 5 is a schematic cross-sectional view of the aortic cannula of FIG. 4;

FIG. 6 is a schematic view of the hyperbaric chamber inside an insulated chest with a heart therein;

FIG. 7 is a top-view schematic of the perfusion pump showing the location of some of the components; and

FIG. 8 is a side-view schematic of the perfusion pump.

### DETAILED DESCRIPTION OF THE INVENTION

This invention relates to an apparatus for maintaining an organ, such as a human heart, which has been excised from the donor, in optimum conditions for transplant to the recipient. The invention is applicable to various such apparatus. As representative of the present invention, FIG. 1 illustrates an apparatus or system 10.

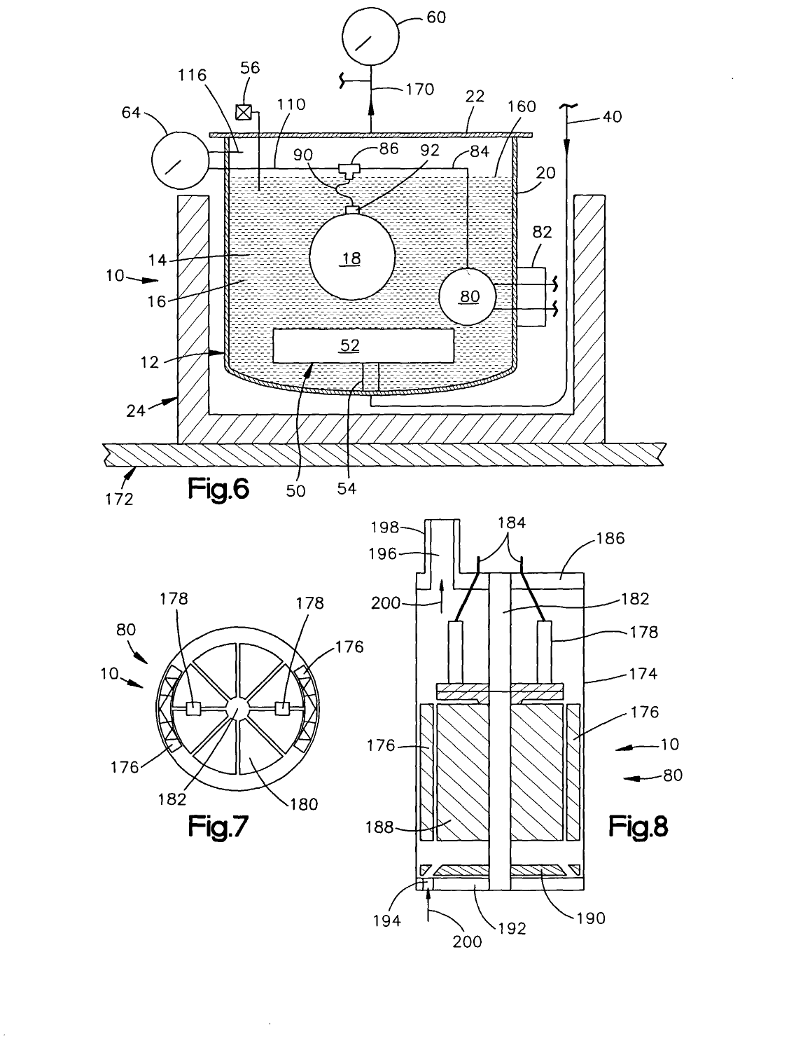

The system 10 includes a container or pressure vessel 12 that defines a hyperbaric chamber 14 containing a physiological fluid or solution or perfusate 16 for an organ 18 (FIG. 6) to be transplanted, such as a heart. The container 12 includes a base portion 20 and a removable cover 22 which has an o-ring for sealing when compressed against a flange of the base portion. Various types of clamps can be used to provide pressure between the cover 22 and the base 20 and are well known to one skilled in the art. One type of clamping mechanism includes four threaded fixtures attached to the container wall and passed through the cover 22, with four similarly threaded nuts to provide the necessary tension.

The container 12 is the only pressure vessel in the system 10, other than a gas supply cylinder 30. The container 12 is designed to contain pressures above atmospheric, as described below.

The system 10 includes an insulated chest 24 (FIG. 6), such as an ice chest, for example, for receiving the container 12. The insulated chest 24 is larger than the container 12 so that the space between the insulated chest and the container 12 can be filled with ice to insure that the perfusate 16 and the heart 18 remain at a low temperature. Alternatively, the insulated chest 24 and the container 12 can be permanently or removably joined together, and/or a cooling system other than ice can be used.

The system 10 also includes a source of gas under pressure. In the illustrated embodiment, the gas source is a high pressure cylinder 30 containing medicinal oxygen or a mixture of gases having oxygen as one of the gases.

The system 10 includes a plurality of flow lines and associated structures for directing gas under pressure into the chamber 14 and out of the chamber. These structures include a cylinder shutoff valve 32, a purge 34 for removing contaminated gas after changing cylinders, and an inlet shutoff valve 36 downstream of the cylinder 30 for isolating the system from the high pressure gas.

A pressure regulator 38 controls the gas inlet pressure to the hyperbaric chamber 14 through a gas inlet line 40. A gas cylinder pressure gauge 42, an inlet pressure gauge 44, and a pressure relief valve 46 for relieving dangerous overpressures are also connected with the hyperbaric container 12.

The system 10 also includes a gas diffuser assembly 50. The purpose of the gas diffuser assembly 50 is to maintain the physiological solution 16 saturated with oxygen to help preserve the heart 18 when the solution is pumped into the heart. The gas diffuser assembly 50 in the illustrated embodiment includes a ground quartz disc 52 (available from a laboratory supply house that makes ground quartz laboratory filters) around 100 millimeters in diameter by around 6 millimeters thick, which is permeable by the gas to be diffused therethrough. The disc 52 is supported by a stainless steel support 54 that is threaded into an oxygen inlet in the bottom of the container 12. The disc 52 is thereby disposed in the fluid 16 in the chamber 14 in the container 12, so that when gas is introduced into the disc as described below, the gas “bubbles” into and through the solution in the chamber.

The system 10 also includes a hyperbaric chamber pressure gauge 60 that is operative to show the pressure in the chamber 14. The system 10 further includes a perfusate sampling valve 56, and a differential pressure gauge 64.

The system also includes a filter 66 for removing dissolved liquid from the gas stream which leaves the hyperbaric chamber 17. A second filter 67 may include, for example, a 50 micron particle filter to insure that solid particles do not pass to the outlet portion of the system that includes downstream flow and pressure controls 70 and 74. The controls 68 include a flow meter and valve 70 for controlling and determining the amount of gas which is flowing through the system 10; a purge valve 72 for reducing pressure in the chamber 14; an adjustable pressure relief valve 74 for maintaining pressure in the chamber; and a pressure relief gauge 76 for determining the pressure in the outlet portion 68 of the system 10.

The system 10 also includes a perfusion pump 80 for pumping physiological solution 16 into the organ 18 in the chamber 14 in the container 12. The perfusion pump 80 is submersible and can be either gas operated or electrically operated. For the purposes of illustration, an electrically operated pump 80 is shown. Preferably, a low voltage direct current pump is used so that the voltage can be easily regulated to control the speed of rotation of the pump, thereby controlling the volume of flow of the pump and thereby the perfusion pressure. The pump 80 receives electric current for operating the pump through an electrical connector 82 designed to permit passage of electrical energy through the wall of the container 12, while sealing against pressure leaks.

The perfusion pump 80 requires an uninterrupted source of direct current electricity variable from 0-12 volts. Either an external source of 110 volt or 220 volts, or a 12-volt rechargeable battery 84 provides this electric energy.

A fluid flow line 84 (FIG. 6) extends from the outlet of the perfusion pump 80 and is connected to a “tee” 86. The other side of the tee 86 is connected to the differential pressure gauge 64 located external to the chamber 14. In addition, the tee 86 is connected by a flexible line 90 to an aortic connector or cannula 92, allowing perfusate to pass from the perfusion pump 80 to the aorta of the heart 18.

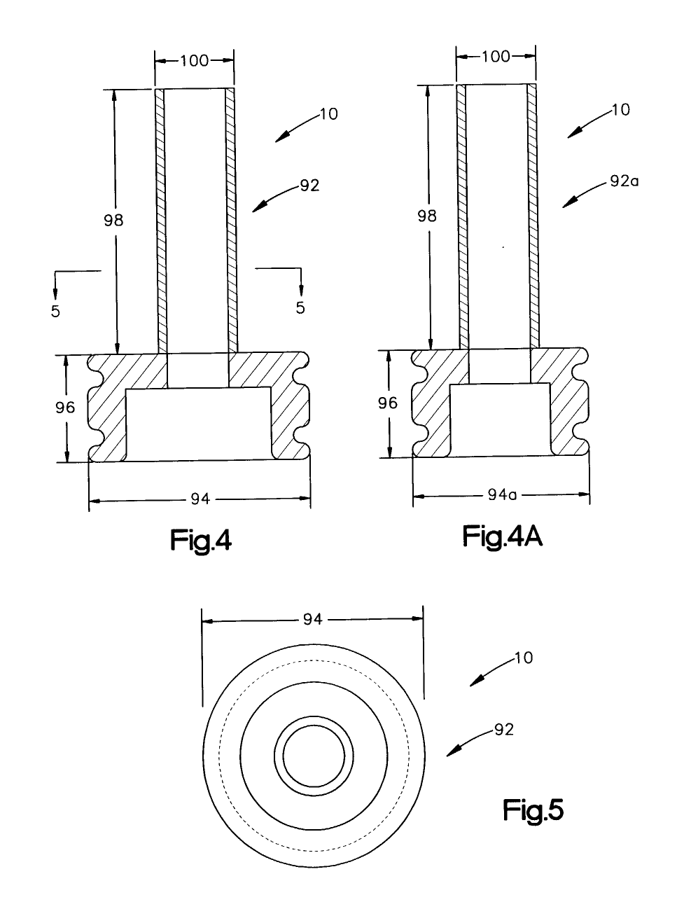

The aortic cannula 92 is approximately the diameter of the aorta of the excised heart 18, having a portion to be inserted into the aorta. The aortic cannula 92 is selected from a kit or group including a variety of cannulas having insertable portions whose external dimension (diameter) or aortic insertion dimension 94 varies in relation to the diameter of the aorta into which the cannula portion is to be inserted for perfusion. For example, FIG. 4A shows an aortic cannula 92a having a smaller aortic insertion dimension 94a. In this way donor hearts of different sizes, from children or adults, can best be accommodated. For each one of the aortic cannulas 92, dimension 96 is approximately 12 millimeters, dimension 98 is approximately 30 millimeters, and dimension 100 corresponds to the approximate diameter of the flexible line 90 to be fitted on the cannula.

Providing the proper pressure is important to the perfusion system 10. The perfusion pressure is measured by the differential pressure gauge 64 and can be regulated from about 10 mm of Hg to more than 200 mm of Hg. Preferably, it should be operated approximately equal to the normal human blood pressures (70-120 mm Hg.). The differential pressure gauge 64 is connected through line 110 to one side of the “tee” 86. The other side of the differential pressure gauge 64 is connected to the interior of the hyperbaric chamber 14 through line 116 above the fill level of the perfusate 16. In this way, the gauge 64 measures the difference between the pressure in the hyperbaric chamber 14 and the perfusion pressure.

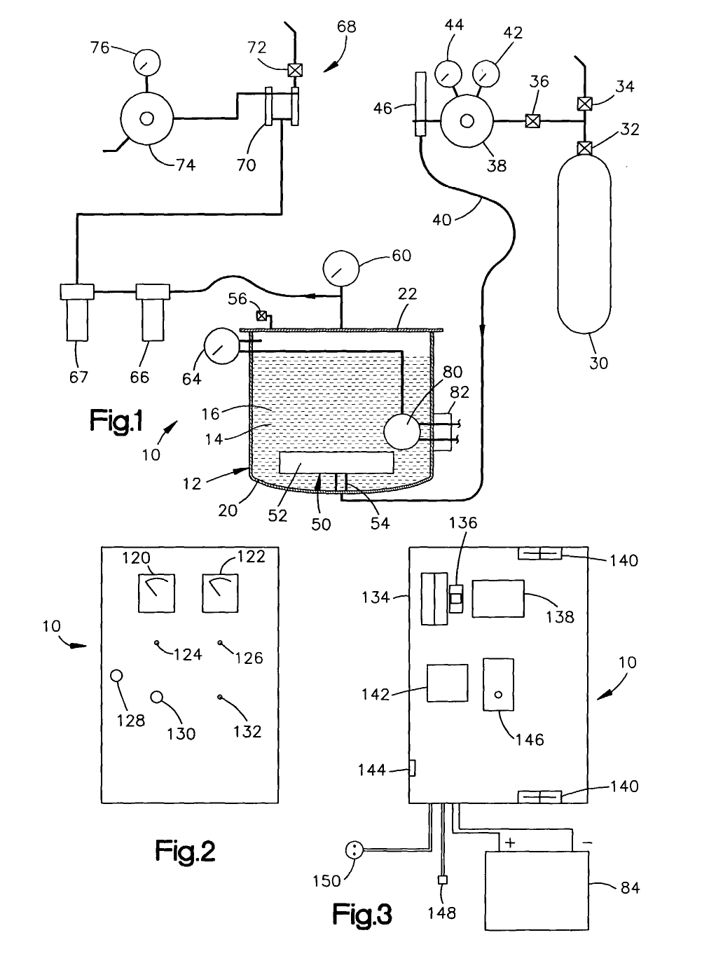

Some of the electrical components of the system are illustrated in FIG. 2. An ammeter 120 is used for determining the amount of current being utilized by the perfusion pump 80. A volt meter 122 is used to determine the voltage going to the perfusion pump 80. The electrical components also include a system-energized light 124, a battery-in-use light 126, a front panel lock 128, an on-off switch 130 for controlling the perfusion pump 80, and a perfusion pump-on indicator light 132 to indicate when the perfusion pump is in operation.

FIG. 3 illustrates additional electrical components of the system 10. These include circuit breakers 134 to protect the circuit from over-voltages; a relay 136 that automatically switches the system to battery power at any time there is no external source of power; and a transformer 138 that reduces voltage from 110 volts or 220 volts to 12 volts. The system 10 may also include one or more ventilation fans 140; a battery charger 142 which provides a constant source of 13.5 volts of direct current from the external power supply; and an external-power-voltage switch 144 for switching from 110 volts to 220 volts of external power. The system also includes a voltage control 146 that transforms 12 volts of alternating current into a source variable from 0-12 volts of direct current; the 12 volt rechargeable battery 84, preferably with a minimum capacity of 40 ampere hours; electrical leads 148 that connect the electrical system to the electrical connector; and an external power plug 150 for connecting the system to a 110 volt or 220 volt source.

By virtue of its general construction and dimensions, the system 10 is highly portable and transportable. Specifically, the system 10 is designed for easy usage in transporting an excised heart 18 or other organ by minimally trained personnel, flying at high altitudes on an airplane.

In one embodiment, the container 12 has the following dimensions: 25 cm by 25 cm by 40 cm high, including the pressure gauge 60 on top. It is of stainless steel construction, weighing about 18 kg when filled with water. An insulated chest 24 of about 35 cm×35 cm×50 cm is typically large enough to hold the container 12 and ice as needed. The valving and associated controls may be included in one or two attachments (cases) that are connected with the container 12 for movement with the container.

The overall system 10 can be assembled into one unit on a base or support shown partially in schematic at 172 (FIG. 6) that enables it to be easily lifted onto an off of an airplane, by means of a baggage cart, for example. The overall system 10 in this configuration would occupy a floor space of about 35 cm by 75 cm, with a height of 60 cm, including the container 12, the electrical controls, all oxygen valving, and the oxygen cylinder 30. The total weight of the system 10, including a 10 kilogram oxygen cylinder 30, would be about 57 kilograms. The system 10 when mounted on a cart can be easily rolled around a hospital, or rolled out to an airplane for transport.

To utilize the system 10, the hyperbaric chamber 14 is filled to a fill level 160 (FIG. 6), which is approximately 40 millimeters from the top, with cold (4° C.) perfusate 16. This perfusate 16 may be a St. Thomas solution, a Wisconsin solution, a Stanford solution, or other solution known to those skilled in the art.

Before the flexible line 90 is connected to the aortic cannula 92, the perfusion pump 80 is connected to the power supply and the pump is turned on. This allows for perfusate 16 to fill the perfusion pump 80, the fluid flow line 84, the “tee” 86, and the flexible line 90, thereby removing any air bubbles that may be in the system 10. Once all air has been removed from the system, the flexible line 90 and the cannula 92 may be connected to the heart 18 as described below.

To turn on the perfusion pump 80, the on-off switch 130 is used. The perfusion pump-on indicator light 132 lights. When the system 10 is near a source of 110-volt or 220-volt electricity, it should be plugged into this external source, utilizing plug 150. Before plugging in the external source, the external-power-voltage switch 144 should be adjusted to the correct voltage. The circuit breakers 134 should be turned on, and the system-energized light 124 should light. When the system 10 is plugged into an external power source, the battery 84 will charge and remain charged until the external power source is disconnected.

The heart 18 is placed in the chamber 14 and immersed in the physiological solution 16. The aortic cannula 92 is inserted into and sealed in the aorta of the heart 18. This is the only connection between the system 10 and the heart 18. When the pump 80 is turned on, the perfusion fluid flows through the cannula into the aorta of the heart 18, in a direction counter to the normal direction of blood flow. This closes the aortic valve, thus forcing the solution 16 in the aorta to flow through the coronary arteries and the vascular bed of the heart.

The voltage, and hence, the rotation speed of perfusion pump 80 is adjusted so that the perfusion pressure, as determined by the differential pressure gauge 64, is within the desired range.

At this point, the hyperbaric chamber cover 22 is fastened to the hyperbaric chamber body 20 and pressurization is started. Specifically, the cylinder shutoff valve 32 is opened, the purge valve 34 is opened briefly to clear the lines, and the pressure regulator 38 is adjusted to a value 0.5 atmospheres gauge (ATG) above the desired pressure in the chamber 14.

Gas flows through the inlet shutoff valve 36 to the inlet pressure regulator 38 where the pressure is reduced to the working pressure of about 0.2 (ATG) above to about 6.0 ATG. The inlet pressure to the chamber 14 is regulated to a pressure slightly above (around 0.5 ATG) the desired hyperbaric chamber pressure in order to provide a flow of gas through the system 10.

Gas flows continuously into and through the system 10 through the gas diffuser 50, through the filter 66 to the outlet portion 68 of the system. Flow valve 70 is opened to allow for gas flow, and pressure relief valve 74 is slowly regulated until the desired hyperbaric chamber pressure is obtained. Since the pressure provided by the perfusion pump 80 is a differential pressure, the perfusion pressure as determined by the differential pressure gauge 64 will remain at about the same pressure value during pressurization.

The gas flows through the gas inlet line 40 to the gas diffuser assembly 50. At the gas diffuser assembly 50 the gas enters the chamber 14 continuously in the form of tiny bubbles that have a high surface area and are easily dissolved in the physiologic solution 16 in the chamber. The gas thereby saturates the physiologic solution 16 in the chamber 14.

Excess gas flows out of the chamber 14 through the outlet 170 (FIG. 6) in the chamber cover 22, and thence through the filter system 66, to the flow meter and regulator 70. At the flow meter and regulator 70 the rate of flow of gas through the system 10 is controlled to a flow of from 0.1 liters per minute to around 1 liter per minute. By increasing the outlet pressure, pressure in the hyperbaric chamber 14 is increased, and by decreasing the outlet pressure, pressure in the hyperbaric chamber is decreased. The gas then flows to the outlet pressure relief regulator or pressure relief valve 74 where the overall pressure in the system 10 is regulated.

The pressure relief valve 74 is needed because of the continuous flow of oxygen through the system 10. By using a pressure relief valve 74 to maintain (control) the pressure in the chamber 14, there is no significant change in the chamber pressure as the pressure outside the chamber decreases (for example, as the system 10 is lifted to a high altitude on board an airplane). As the pressure outside the chamber 14 decreases, there may be a slight increase in gas flow through the system 10. Thus, the present invention is especially suited for use at high altitudes (low ambient pressures) as are experienced in an airplane transporting the heart 18.

The perfusate solution 16 in the chamber 14 has significantly less viscosity than human blood. Therefore, the volume of solution 16 pumped must be increased in relation to the normal amount of blood pumped through the coronary arteries, in order to maintain a similar amount of perfusion pressure. The arterial bed of the heart 18 provides a load against which the perfusion pump 80 pumps. Varying the rotation speed of the perfusion pump 80 varies the volume of perfusate 16 being pumped, and therefore, the perfusion pressure. The ability to vary the volume of perfusate 16 being pumped means that hearts of all sizes may be accommodated, from children's hearts to adult hearts.

The system 10 provides for continuous oxygenation of the perfusate 16. Specifically, continuous oxygenation of the perfusate 16 results from the flow of gas through the gas inlet line 40, through the gas diffuser assembly 50 into the perfusate 16. Part of the gas flowing into the chamber 14 is dissolved to saturate the perfusate 16. Excess gas leaves the chamber through outlet 170. The pressure in the chamber 14 is measured by the hyperbaric-chamber pressure gauge 60. The perfusate 16 may be sampled, at any time that the hyperbaric chamber 14 is pressurized, by opening the perfusate sampling valve 56.

The procedure for decompression of the chamber 14 is as follows. The inlet shutoff valve 36 is closed, along with the flow meter valve 70. The purge valve 72 is opened. The flow meter valve 70 is adjusted to the desired flow rate (approximately 0.1-0.3 liters per minute), which will allow for slow decompression of the chamber 14. During decompression, the perfusion pump 80 must remain in operation in order to maintain an overpressure in the perfusate circulation system. This overpressure will prevent the formation of gas bubbles in the perfusate circulation system and the arterial bed of the heart 18 during decompression, thereby preventing an embolism.

When the system 10 is disconnected from an external source of electrical power, it will automatically switch to battery power, and the battery-in-use light 126 will light. The perfusion pump 80 will remain functioning. At maximum voltage, the pump 80 will utilize around 3 amperes of current, so a 40 ampere-hour battery 84 will give at least 8 hours of continuous use. A larger battery 84 would increase this time if more time were necessary.

When the hyperbaric container 12 is functioning, it should quickly be placed in the insulated chest 24. The space between the insulated chest 24 and the container 12 should be filled with ice to insure that the perfusate 16 and the heart 18 remain at a low temperature.

FIGS. 7 and 8 are schematic diagrams of one type of submerged perfusion pump, which might be employed in the device. Other types of perfusion pumps may also work, including compressed-gas operated perfusion pumps. FIG. 7 shows one position of some of the components. The body 174 of the perfusion pump 80 supports permanent magnets 176 of which there are two or more; carbon brushes 178 for transmitting direct current electricity to a commutator 180 that is attached to a motor shaft 182.

Other components of the perfusion pump include electrical connections 184 for receiving electric energy from the connector 82; an outlet cap 186; the motor rotor 188, which is fixed on the motor shaft 182. The pump also includes a turbine 190 for propelling the perfusate 16 through the pump 80, an inlet cap 192, a pump inlet 194, a pump outlet 196, and an outlet nipple 198 for connecting the outlet line 84 to the perfusion pump 80. The commutator 180, the rotor 188, and the turbine 190 are all fixed to the motor shaft 182 which rotates. The inlet cap 192 and the outlet cap 186 support the motor shaft 182. The two arrows 200 indicate the direction of flow of the perfusate 16 through the pump 80. The perfusate 16 enters the pump 80 through the inlet 194, is propelled upward by the turbine 190, and passes between the pump rotor 188 and the pump body 174, to the outlet 196. The pump 80 may also be operated in the horizontal position as well as inverted, as long as the pump inlet 194 is submerged in the perfusate. Pumps 80 of this type are well known in the art and are manufactured by a number of companies for other applications.

From the above description of the invention, those skilled in the art will perceive improvements, changes, and modifications in the invention. Such improvements, changes, and modifications within the skill of the art are intended to be included within the scope of the appended claims.

Having described the invention, we claim:

1. An apparatus for transporting and maintaining an excised heart in condition for transplantation, the heart having an aorta, an aortic valve at the entrance to the aorta, and coronary arteries, said apparatus comprising:
a container defining a chamber for receiving the heart;
a body of physiologic fluid disposed in the chamber;
a pump for pumping said fluid into the heart;
a source of oxygen under pressure;
oxygen flow structure for continuously directing flow of pressurized oxygen into said body of fluid in said chamber thereby to oxygenate said fluid and to maintain the pressure in the chamber at a pressure above atmospheric pressure; and
fluid flow structure for directing flow of fluid from said pump to said heart, including an aorta supply line for directing fluid from said pump to the aorta of the heart and thence into the coronary arteries of the heart to force perfusion of the vascular bed of the heart.

2. An apparatus as set forth in claim 1 further including a connector for connecting said aorta supply line with the aorta to couple the fluid output of said aorta supply line to the aorta, thereby to direct fluid to flow into the aorta of the heart.

3. An apparatus as set forth in claim 2 wherein said connector is a cannula having a portion that is insertable into the aorta.

4. An apparatus as set forth in claim 2 including a plurality of said connectors of different sizes to fit differently sized aortas.

5. An apparatus as set forth in claim 1 wherein said oxygen flow structure includes a gas diffuser assembly in said chamber for providing continuous oxygen flow into the body of fluid in said chamber through bubbling of gas into said fluid thereby to oxygenate said fluid and to maintain the pressure in the chamber at a pressure above atmospheric pressure.

6. An apparatus as set forth in claim 5 wherein said pump has an inlet immersed in said fluid, said pump inlet taking in oxygenated fluid and said pump directing said oxygenated fluid into the aorta of the heart.

7. An apparatus as set forth in claim 6 further including a connector engageable with the aorta of the heart for connecting an aorta supply line between said pump and the aorta to couple the fluid output of said pump to the aorta, thereby to direct oxygenated fluid to flow into the aorta of the heart in a counter flow manner.

8. An apparatus as set forth in claim 6 wherein said pump has an adjustable flow rate to adjust perfusion pressure thereby to compensate for the size of the heart being perfused.

9. Apparatus as set forth in claim 1 including a pressure relief valve operable to maintain pressure in said chamber in response to a decrease in ambient pressure around said system.

10. An apparatus as set forth in claim 1 further including a power supply system including a battery external to said chamber and means for receiving 110v or 220v power and in which said system is automatically battery powered when not receiving 110v or 220v power and in which said battery automatically recharges when said system is receiving 110v or 220v power.

11. Apparatus as set forth in claim 1 that is portable and that can be used within a space of about 35 cm by 75 cm by 60 cm high and that can be assembled into one unit on a base or support structure that enables it to be easily lifted or rolled around.

12. An apparatus as set forth in claim 1 wherein the only connection between said apparatus and the heart is an aortic connection.

13. An apparatus as set forth in claim 1 further including cooling structure for cooling said fluid to help preserve the heart.

14. An apparatus for transporting and maintaining an excised heart in condition for transplantation, the heart having an aorta, an aortic valve at the entrance to the aorta, and coronary arteries, said apparatus comprising:
a container defining a chamber for receiving the heart;
a body of physiologic fluid disposed in the chamber;
a pump for pumping said fluid into the heart;
a source of oxygen under pressure;
oxygen flow structure for directing flow of pressurized oxygen into said body of fluid in said chamber thereby to oxygenate said fluid and to maintain the pressure in the chamber at a pressure above atmospheric pressure, said oxygen flow structure including a gas diffuser assembly in said chamber for providing oxygen flow into the body of fluid in said chamber through bubbling of gas into said fluid; and
fluid flow structure for directing flow of fluid from said pump to said heart.

15. An apparatus as set forth in claim 14 wherein said oxygen flow structure is operative to provide continuous flow of oxygen into said fluid through bubbling.

16. An apparatus as set forth in claim 14 wherein said fluid flow structure includes an aorta supply line for directing fluid from said pump to the aorta of the heart and thence into the coronary arteries of the heart to force perfusion of the vascular bed of the heart.

17. An apparatus as set forth in claim 14 further including a plurality of connectors for connecting said aorta supply line with the aorta to couple the fluid output of said aorta supply line to the aorta, thereby to direct fluid to flow into the aorta of the heart, said plurality of connectors being of different sizes to fit differently sized aortas.

18. Apparatus as set forth in claim 14 including a pressure relief valve operable to maintain pressure in said chamber in response to a decrease in ambient pressure around said system.

19. Apparatus as set forth in claim 1 that is portable and that can be used within a space of about 35 cm by 75 cm by 60 cm high and that can be assembled into one unit on a base or support structure that enables it to be easily lifted or rolled around.
